(19) United States
(12) Patent Application Publication
(10) Pub. No.: US 2022/0129246 A1
(43) Pub. Date: Apr. 28, 2022

(54) Functional Method for Universal Computation by Extended Formal Matrix Product

(71) Applicants: Gaëll Jane GUIBERT-SAUZAY, CROZON (FR); Michel Edouard GUIBERT, CROZON (FR)

(72) Inventors: Gaëll Jane GUIBERT-SAUZAY, CROZON (FR); Michel Edouard GUIBERT, CROZON (FR)

(21) Appl. No.: 17/310,638

(22) PCT Filed: Mar. 11, 2020
(86) PCT No.: PCT/FR2020/000054

§ 371 Date: Aug. 13, 2021

(30) Foreign Application Priority Data
Apr. 14, 2019 (FR) FR1903969

(51) Int. Cl. G06F 7/523; G06F 17/16; G06F 5/01

(52) U.S. Cl. CPC G06F 7/523; G06F 5/01; G06F 17/16

(57) ABSTRACT

Functional Method for Universal Computation by Extended Formal Matrix Product. The invention targets central processing units (1) that can be programmed by functional software devices (3) relying on the sole notion of application, (6) to (10), without any set of instructions whose complex sequential decoding is opposed to a parallelism independent of the software devices themselves (3), allowing, by the product (5) of binary matrices (2), a first parallelism said technical (24), autonomous and independent of functional algorithms, nevertheless performing these latter in a parallel way independently of their initial description (3). A second parallelism, said applicative, constituted by binary diagonally matrix (4) extended with indexes (13) situated inside the technical parallelism (2), performs simultaneously several tasks (4), always without instructions, nor task scheduler. The method is constituted of an extended matrix product operation (24) on two set of memory words, (13) to (16), representing two triangular matrix (2), such that one allows to write the result of the product of its opposite (extended to a square matrix) by itself and reciprocally (2), according to three phases, called application (A), expansion (E) and reduction (R). The results are expressed by some binary connections (24) defined by the binary product between lines and columns. The software devices are vectors (17) of sequences of binary diagonally matrix (4) extended with index words (13) for each dimension, referring to positions into the software device (17). The method according to the invention is particularly intended to formal intrinsic computations (6), in computer science and in cognitive semantic.

The present invention relates to a Functional Method for Universal Computation by Extended Formal Matrix Product for performing applicative computation (6) to (10) by means of a central processing unit (1) and the corresponding software device (17), without instructions or task scheduler.

The method according to the invention allows to produce a level of parallelism that is totally independent of the so-called universal algorithms which are nevertheless performed.

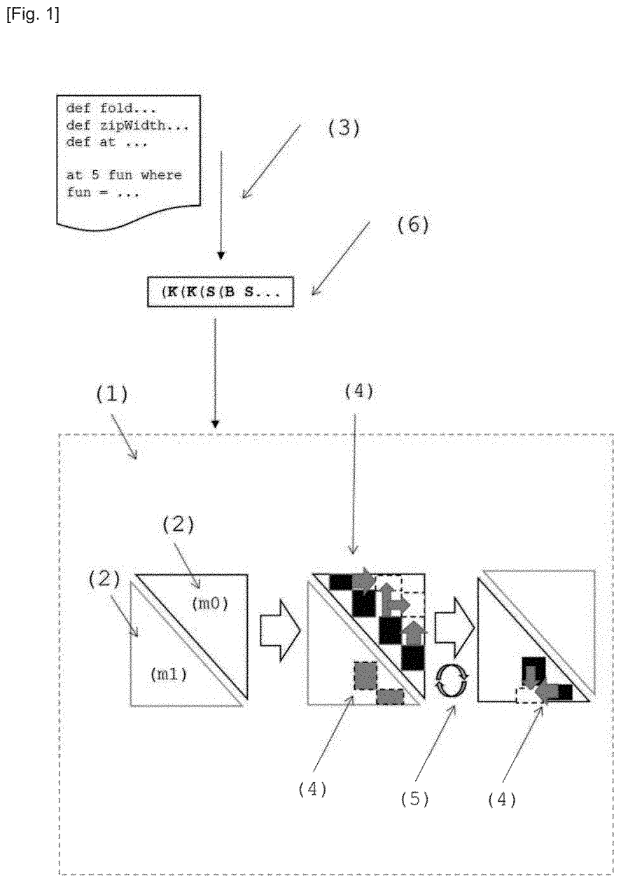

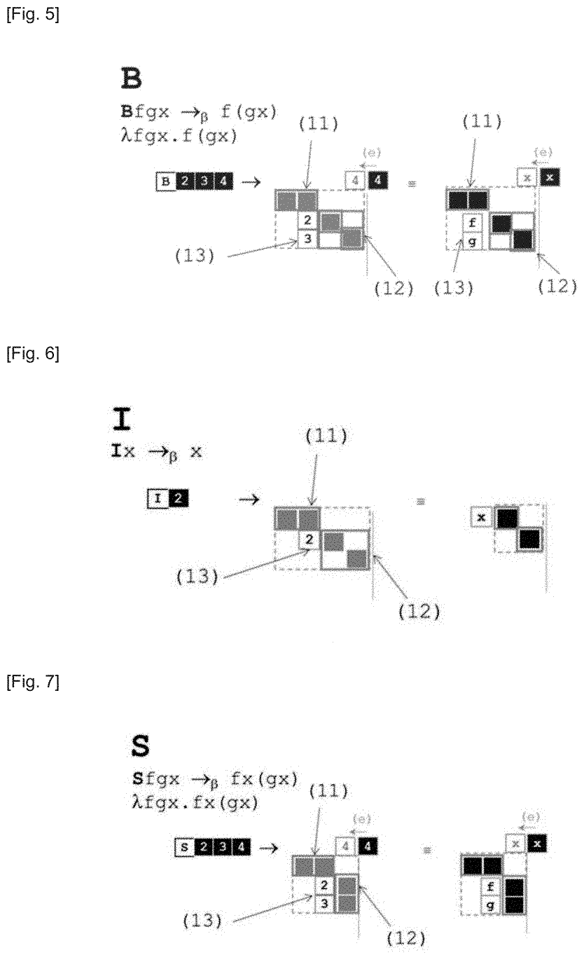

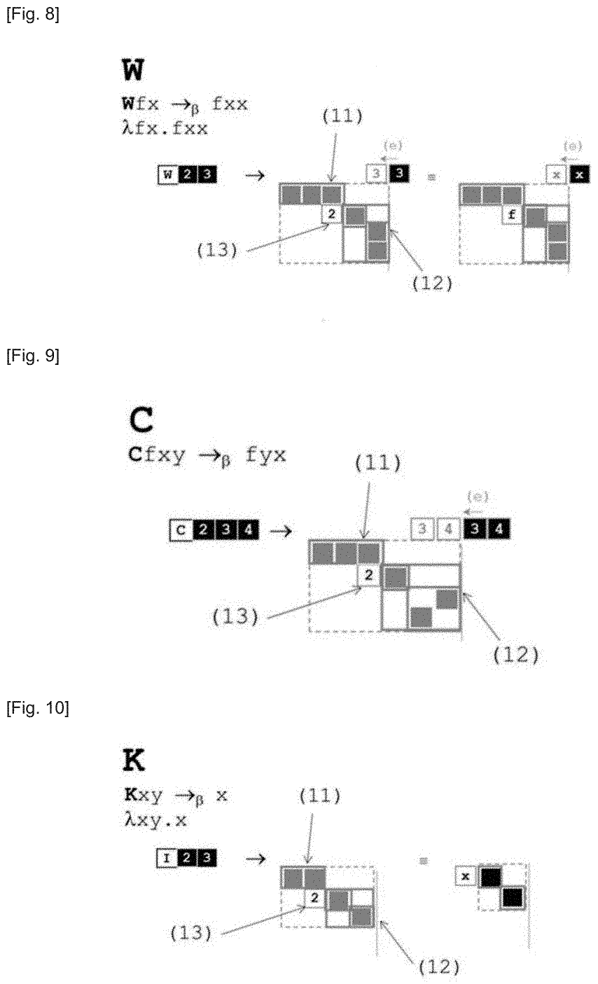

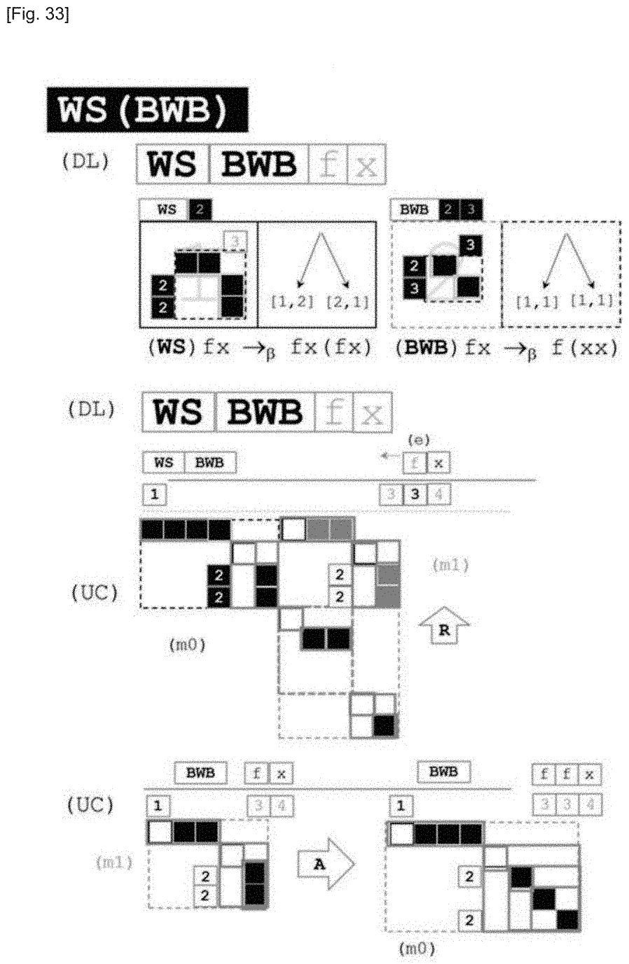

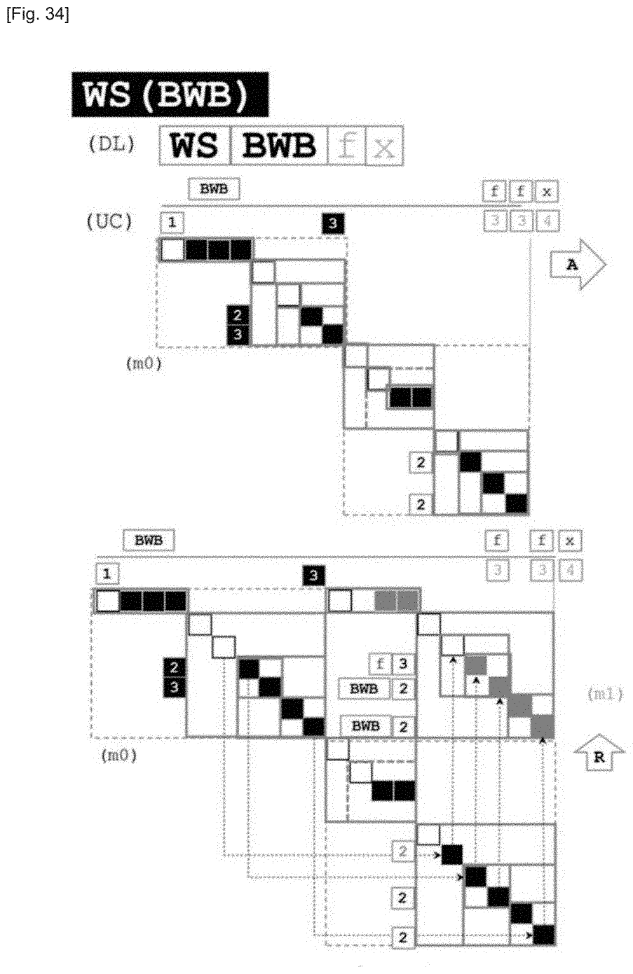

In the context of the present method [FIG. 1], it is not necessary, unlike central processing units with instructions, to modify the said central unit with instructions processing, for the latter to perform some complex operations in a manner identical to those implemented by the said instructions: see on this point the «simple» computations, [FIG. 5] to [FIG. 10], and then the «complex» computations, [FIG. 33] to [FIG. 34].

The framework of the present invention is that of the applicative systems (or purely applicative) in that it is defined by the sole operation of application; the latter is characterized in the present invention as a binary relation (line, column) internal to the matrix product.

The present method thus differs from the so-called quasi-applicative systems, whose lambda-calculus is a particular case.

The associated software devices are word ordered matrices (17) where the «line-column» relation represents the concept of operator (eventually «abstract»), which differs from that of the abstract function.

The present method directly performs, by a «functional» method, the Combinatory Logic of H. B. Curry (and the lambda-calculus of A. Church, by defining, by the known algorithms, the abstraction operation of the lambda-calculus from that of application) and is fully integrated into the computer development chain of the high-level programming languages (3).

The compilation of the «high level» universal software devices (3) to the central processing unit (1) object of the present invention is carried out by the existing compilation algorithms to the Combinatory Logic of H. B. Curry, and can be carried out by the present central processing unit with regard to the said applicative computations (6) to (10).

The various given descriptions in the present invention will therefore use the same representations or symbols, called combinators, than those given by H. B. Curry (1958).

In the present invention, the combinatorial transformations of Combinatory Logic are operational binary transformations or «applicative» transformations (6) to (10), internal (4) to the matrix product, which generate other binary «applicative» matrix transformations (6) to (10) via indexes that refer to positions or places in the said software device (17).

In some approaches for implementing Combinatory Logic, which are distinct from the present method, the computations rely directly on the symbols (6) which are then interpreted directly as instructions of an instruction machine or equivalently referred to as von Neumann (so-called «SKI» approaches).

Further approaches, known as «graphs reduction», use software devices based on instructions and pointers of a von Neumann machine, absent from the present method.

In the context of the present invention, Combinatory Logic is also distinguished; naturally, from Hilbert style deduction systems because their axioms system cannot be composed within the meaning of the present invention.

In the framework of the present invention, combinators of Curry are then considered as synonyms of matrices extended with indexes and playing an operative role in a sequence of matrix products and, as a consequence, synonyms of «matrix product».

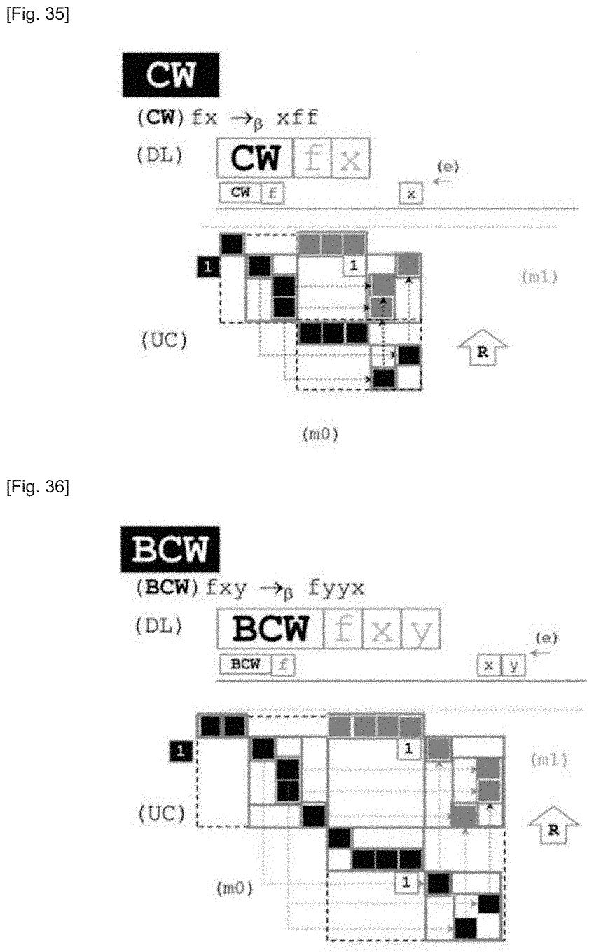

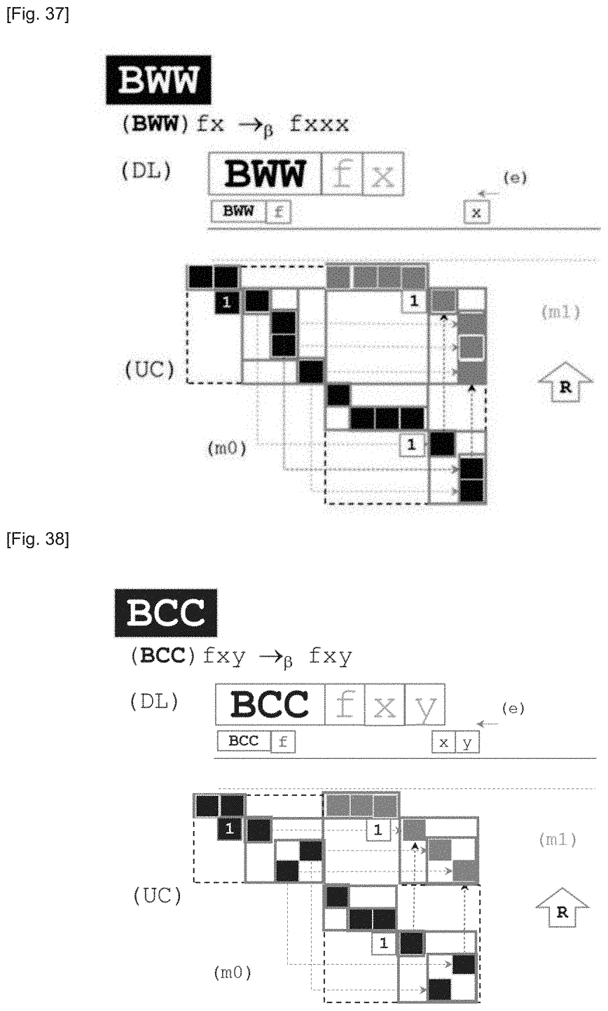

The present invention thus enables the automatic construction of new software devices, smaller, by composition of binary diagonal matrices, that is without necessarily passing through the intermediate results or the corresponding calculations (see in this regard the synthesis of the complex applications ‘CW’ [FIG. 35], ‘BCW’ [FIG. 36], ‘BWW’ [FIG. 37] and ‘BCC’ [FIG. 38]).

As mentioned above, it is not necessary to modify the said central processing unit in order to make perform by the latter the new calculation exactly in the same way as if they were operating primitives: ‘(BWW)’ acting «exactly as» ‘B’ ou ‘W’.

The expression of combinators from Combinatory Logic are thus «reunited» or reduced to extended binary matrix products with their own applicative meaning or their «own operative role».

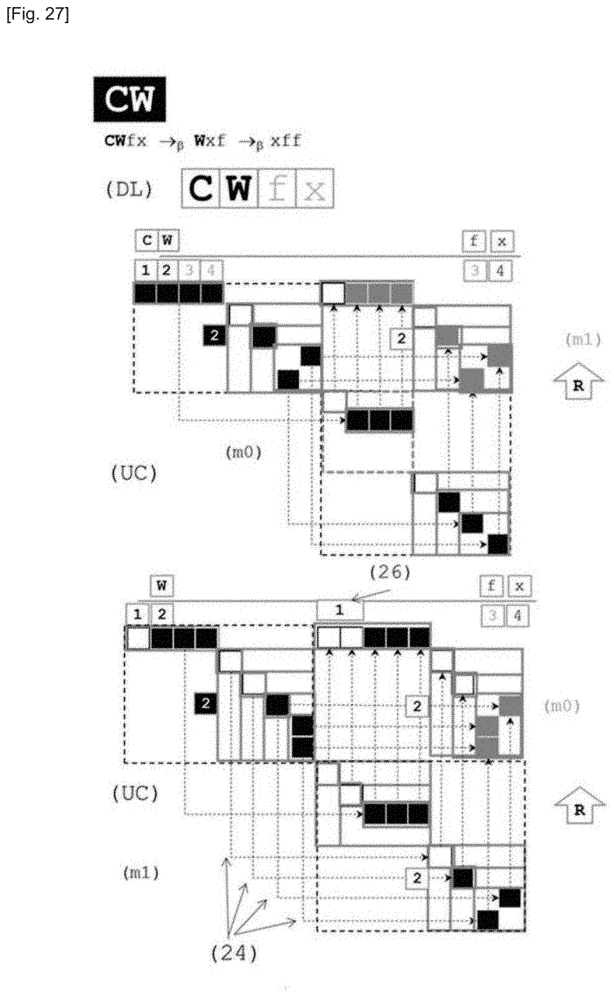

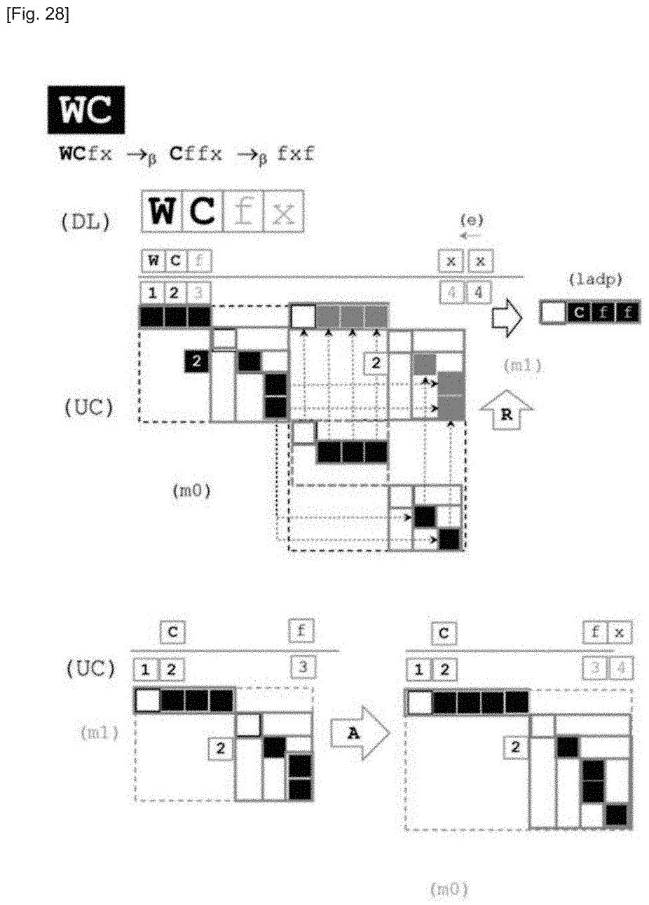

It will be noted that the computation ‘SB’ [FIG. 27] where the resulting computation cannot be reduced to a «single» product of two matrices due to the existence of two applications internal to another application: ‘fx’ then ‘(fx)y’ in ‘x( . . . )’.

It is then necessary to «extend» the matrix product operation by modifying the structure of the diagonal matrix at the same reading value of the result so that the sole index application in the matrix product is given by the head expression according to the traversal order of the said product.

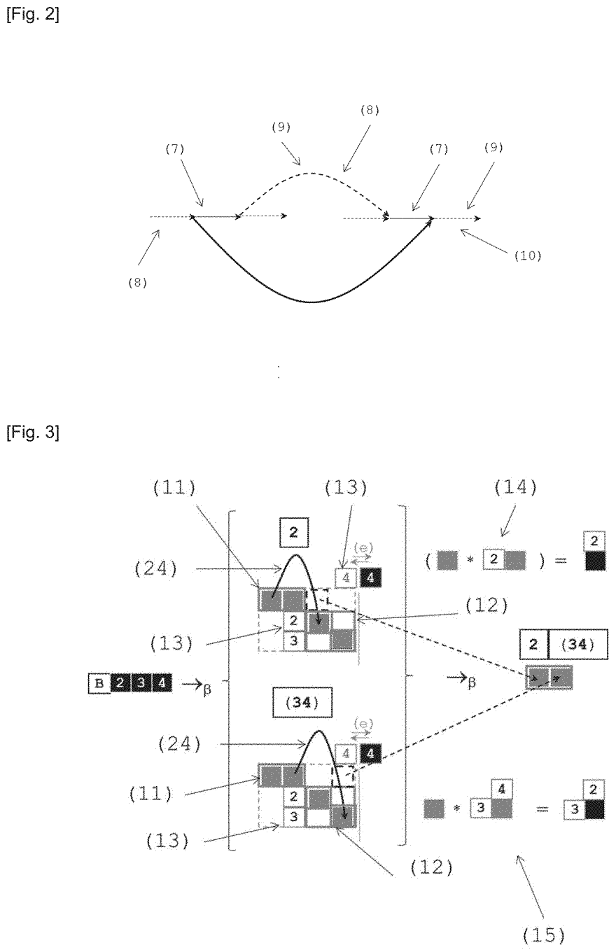

Thus, by removing the intermediate results, when (8)=(9) [FIG. 2] or when the combinators can be composed, the software devices reduce or synthetize themselves into smaller devices, while keeping the final result (10) equivalent to the succession of applications.

This new «compound» computation (Curry—1948), then has, by definition, exactly the same final result (10) as the corresponding sequence of the «compounds» (9); by contrast, it has the properties of having been constructed without passing through the series of intermediate results, and without necessarily establishing explicitly the construction of the result of this new computation.

In the present invention, the reading above the matrix product therefore takes the «shortest path» from [FIG. 2] by the matrix product illustrated by (24) in the [FIG. 3], instead of the simple succession or sequence of applications, the latter being a generator of long sequences of instructions in the referred to as von Neumann machines.

In the context of the present invention, a significant distinction is therefore made between the series of computations in which the intermediate results of the ones (9) serve as inputs to the following ones, and the composition of computations (combinators) that truly constructs a new computation (combinators) from several others.

The idea of the present invention aims by this way to solve the issue of the definition of a method for automatically constructing a new computation: from several others; eventually non-distinct; in a completely «blind» manner, that is without effectively be aware of neither: the intermediate results (9) of the intermediate computations; nor that of the obtained computations (10), in a first time; but such that these results can effectively be obtained if necessary in a second time; and the final result of the computation obtained (10) being the same as that by the corresponding succession of the first computations with their intermediate results (9).

In the context of the present invention, the answer to the issue is carried out in three stages:

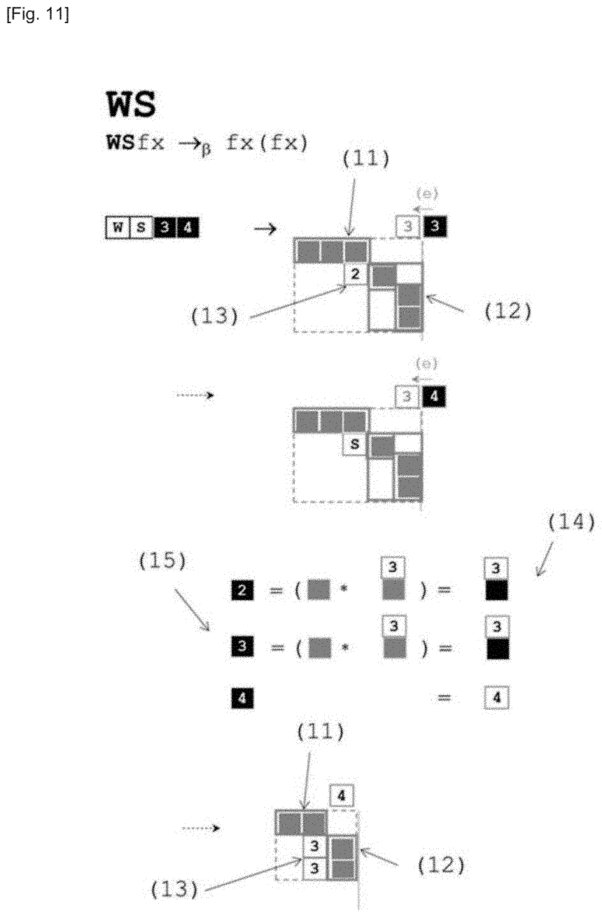

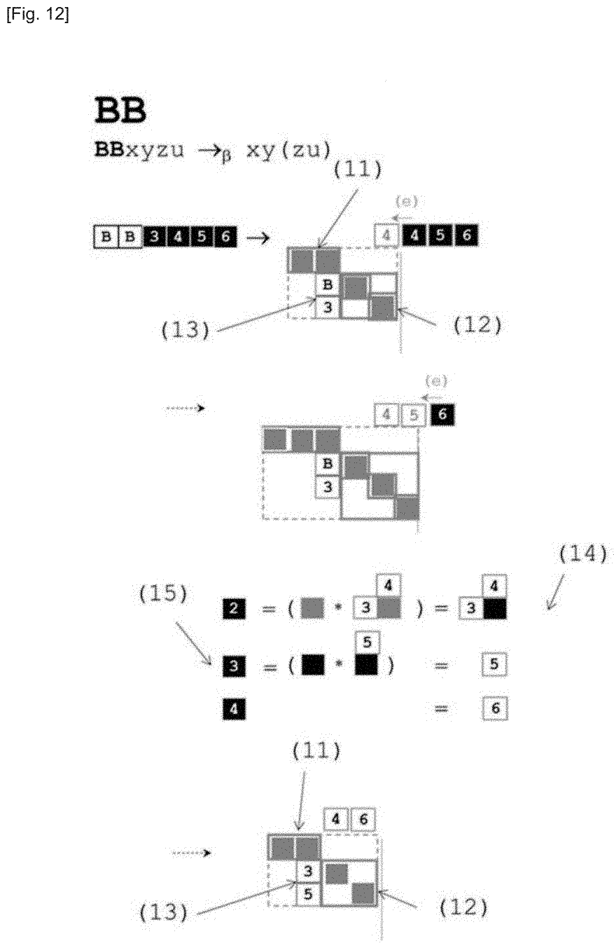

Firstly, the computations (matrix), identified on the basis of elementary computations (combinators) from which all the others (applicative expressions) can be constructed, are defined «outside» the matrix product: [FIG. 5] to [FIG. 10], then [FIG. 11] and [FIG. 12].

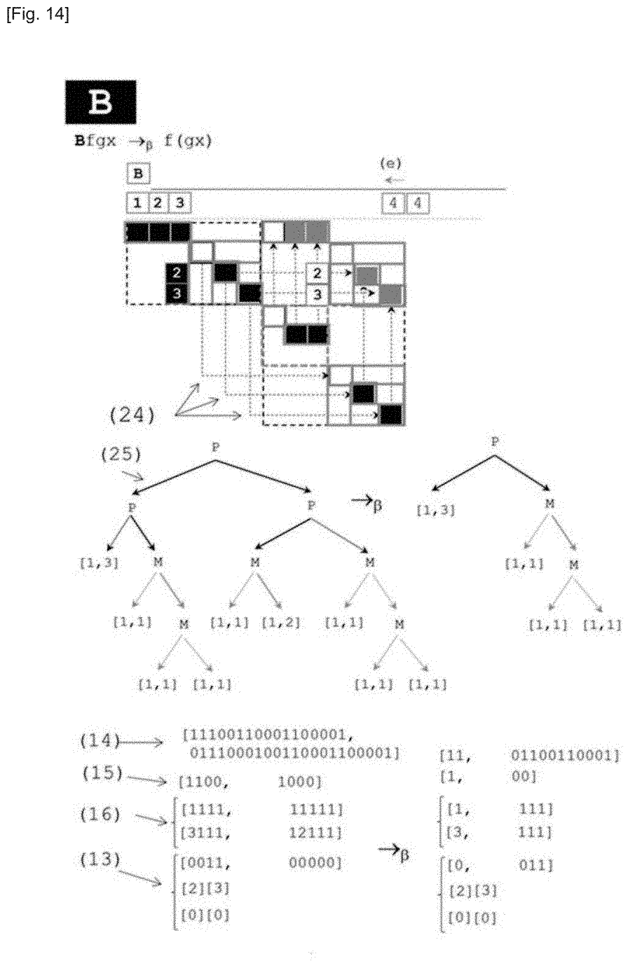

In a second time, applicative computations are integrated in the matrix computation itself, in order to not induce complex operations outside the latter; at this level, the intermediate results (9) are given by particular products: [FIG. 14] to [FIG. 34].

In a third time, the intermediate results (applications), which have become unnecessary, are deleted when the conditions are met: figures [FIG. 35] to [FIG. 38].

In this context, the present method proposes a first level of so-called technical parallelism (24), autonomous and independent of the functional algorithms (3), nevertheless performing these latter in a parallel manner independently of their initial description (3).

This «technical» parallelism, linked to the matrix computation, is totally independent of all of the so-called applicative algorithms then represented by the binary internal relations to the said matrix product.

The second parallelism, said applicative [FIG. 14], constituted by binary diagonally matrices (4) extended by indexes (13) situated inside the technical parallelism (2) and done by the latter, simultaneously «performs» several tasks (4), still without instructions, or task scheduler.

Any expression, then so-called applicative, is thus constructed or read from the said binary diagonally matrices: the order of the current values of the applicative expressions (6) is given by the order formed by the product (24) of the said binary matrices (4) and each value (6) is effectively given by the values of the said indexes (13) associated to each dimension, corresponding to the values «true» or «1» of the said binary matrices (4) of the current part (2), read according to the said traversal order (24).

The said construction of the applicative expressions, or in an equivalent way of reading of these latter, the interpretation of which may eventually contains parentheses, is so-called in the context of the present method «reading above the matrix product».

The said construction, based on the representation from binary values in a matrix product and putting in relation indexes, allows to remove the reading ambiguity between the application of an expression to another and the result of this application sometimes marked by parentheses.

Example I: The left matrix or word ‘▪.▪’ represents any «binary» expression as for example ‘(Wf)x’, ‘(fy)x’ or ‘(fx)(gx)’, or again ‘(fx)x’.

The differences between these expressions are given by the composition with the associated right matrix ‘2x_’.

If the binary combinator W is considered in the expression ‘(Wf)x’, the computation is «blocked» in the absence of «currying» because the parentheses mark the result of the application of W to ‘f’; if the left parentheses have no influence on the final result, they cannot be removed arbitrarily in ‘(Wf)x’.

Example II: The left matrix or word ‘▪.▪.▪’ represents any expression «ternary» as for example ‘Wfx’, ‘fyx’ or ‘fx(gx)’, or ‘fxx’.

The differences between these expressions are given by the composition with the associated right matrix ‘3x_’; there is no intermediate result except the expression ‘(gx)’ in ‘fx(gx)’.

Example III: «regular» is said of a combinator or matrix whose value of the first column of the first line of the right matrix of the corresponding matrix product is ‘▪’.

The product ‘▪*▪=▪’ between the matrices of the first columns of each line does not introduce any change in the first column of the first line of the result.

Example IV: See the transformation associated to combinator B in the illustration [FIG. 3]; the left matrix of the matrix product (11), is composed in parallel (technical parallelism) with the right matrix (12), such that the product «above» establishes connections between indexes or places associated with lines or columns (13).

In the said illustration, such a resulting application ‘2(34)’ cannot be represented by the present method since only one number may be associated with a line or a column and not an application of number or index.

The present method therefore «extends» the matrix product operation into three phases (A), (E) and (R), described later in the present invention, such as the principle to have only one number or index associated to a line or column is respected ([FIG. 14] to [FIG. 34]).

The example is given as an understanding in the first part of the answer to the present issue; the second part will systematize the fact to put all applications inside the matrix product itself.

Still in [FIG. 3], the two computations «outside» the current matrix product, and which are also matrix products, are represented by (14) and (15).

Therefore be the data of a word (line) or of several binary words (composed), constituting a matrix or product, of the form: ‘▪ . . . ▪’ where each ‘▪’, synonymous of «true» or ‘1’ represents:

An applicative relation (or a relation between an input or column and an output or line) between: the column relative to its position in the current word and the current line; another column and another line by adding an integer number (13) relative to the current column or the current line, representing an index in the word matrix of the current software device (17).

An applicative subexpression which is obtained by the composition of the said word with another matrix where the same principles apply, and by the reading above the product, and so on.

When the value is ‘▪’ or «1» there is application, when the value is □ («false» or ‘0’), there is no application.

The present method applies the following rules of the binary «product»: ▪*▪=▪; ▪*□=□: □*▪=□; □*□=□.

The present method applies the following rules of the «sum»: ▪+▪=▪; ▪+□=▪; □+▪=▪; □+□=□.

All of the matrix representations are entirely binary, only the lines and columns can be added with the maximum of an integer number per line and per column.

The method according to the present invention is mainly based on matrix products which are representations in the plan R² or the two-dimensional space or more.

These representations are not usual of the «numerical» machines; other isomorphic representations are therefore necessary to allow the method to be effectively carried out by means of a central processing unit.

It is defined that the matrix product is a particular case of the tensor product that generalizes it to dimensions greater than two, while relying on a product «line-column».

A system thus obtained can be compared, only by the number of manipulated dimensions (2 and more), to the so-called «neural networks» systems; indeed, the present method then constitutes a network of «formal neurons» relying on the concept of application via binary matrices of dimensions greater than two.

The implementation of such a system requires integrating into the words that follow several dimensions, that is words or tables of dimensions greater than two, by adding words of integer encoding these dimensions and the sum of the products of these dimensions to allow access through index words of length equals to the dimension of the manipulated matrices.

The tensor product algorithm may then be deduced from that of the matrix product, by decomposing the product in subproducts of smaller dimensions until it becomes equivalent to a «line column» product.

The whole then forms chains of structured products in significant formal little chains, that can be compared to internal formal expressions of the software device; these formal elements, and respectively these formal little chains, may then compose themselves into formal chains, double, or triple, or in some more complex structures, and then be computed identically.

The construction of a processing unit based on the tensor product or the generalized matrix product rely on given principles by the present method, extended to dimensions greater than two.

In the same way as the matrix product allows the construction of a level of technical parallelism, the tensor product allows the extension of the technical parallelism level to take into account matrices of dimensions greater than two.

The matrices or matrix products are therefore represented in the form of a Directed Ordered Acyclic Graph (from now on DOAG) structure (25) where each internal node of the said structure represents either a matrix product (P) or a diagonally matrix (M).

This DOAG structure (25) is in turn represented in the form of binary words extended with index words.

To perform effectively a numerical machine, the representation in the form of binary words is chosen, while keeping properties of the representation in the form of a matrix (and those in the form of a DOAG «product»).

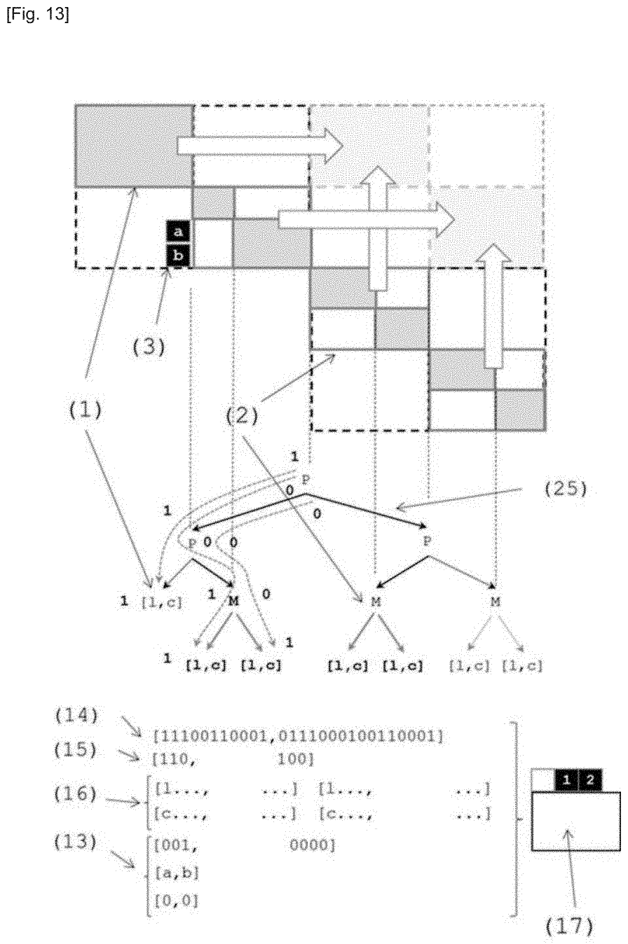

The transformation or encoding of the DOAG into words is performed by the following chaining procedure [FIG. 13]:

In a left-to-right DOAG traversal, starting from the root, the latter may eventually be fictitious if one wanted to implement some «applicative» parallelism or in an equivalent manner, several simultaneous or parallel entangled DOAGs (sharing a same «fictitious» root).

By successive readings [FIG. 13] from the root to the leaves, ‘1’ is marked when the node has not already been passed and ‘0’ when the node has already been passed.

The encoding always starts with a word of ‘1’ that defines the path from the root to the first leaf which is the more on the left; a word is obtained (or a binary vector) and represented in the form of a particular vector (14) of which the number of columns is even or multiple of two times the number of parallel applications.

The present method traverses, manages, handles, thus simultaneously all the columns “two by two” of the said vector.

The matrix product structure, attached to this DOAG, then relies on another binary word (15) where the ‘1’ characterizes an internal node of the DOAG as a product, and the ‘0’ as a diagonally matrix containing other matrices, either also diagonally, or terminal binary leaf matrices; this binary word is constituted by the same path of reading as the DOAG corresponding structure, but each ‘1’ or ‘0’ marks only an internal node of the DOAG structure.

Thus a leaf is identified as a ‘1’ followed by a ‘0’ or of the end of the word defining the DOAG «product».

As well as for the DOAG structure, this word is represented (15) by a vector whose column number is even and according to the applicative parallelism.

To each leaf of the DOAG corresponds a binary matrix {0,1}; that is the information relating to the line number and the column number, and also the binary values of the said matrix.

The line and column informations can also be represented by words of integer for lines and respectively for columns organized according to the same DOAG structure and the matrix product structure such that the DOAG traversal allows to access the corresponding data in the matrices; these words of lines and columns are represented by (16).

Each line and column of each matrix (leaf) can be extended (according to the different combinators) with a maximum of one positive integer (per line and per column) representing indexes or positions in a word of matrix product (17); if such an information is not present, the index is given by the current column in the reading above the product.

Index (strictly positive) designing places in a word of matrix product (17) forming the software device associated to the central processing unit define an annotation word of the leaves, in the same way that the concept of product (P) and of diagonally matrix (M) annotate the internal nodes of the DOAG structure.

Adding these annotations on the leaves is performed by a supplementary vector representing the annotations (13) associated to the matrices whose number of column is multiple of two, followed by words (13) of corresponding indexes data.

A word of integers is defined thus for the lines and another for the columns of the terminal matrix; ‘0’ is not considered as an index value.

Always in [FIG. 13], the set of the words can easily be represented by a word structure (17) representing an element of a software device and containing some elements of different sizes, that is indexed by the sum of the products of the respective sizes for each sub-element.

The integration of external operations as arithmetic or logical operations computed by dedicated computational units, is performed by adding the corresponding information of the said external operations by words or supplementary annotations to the DOAG.

If the presence of an index refers to some internal operations to the matrix product, the presence of another «annotation» in another word, of the DOAG causes the corresponding operation to start such as the result is associated to an input of the following composition; we will make sure that there is only one annotation value or one order in the taking into account by the central processing unit.

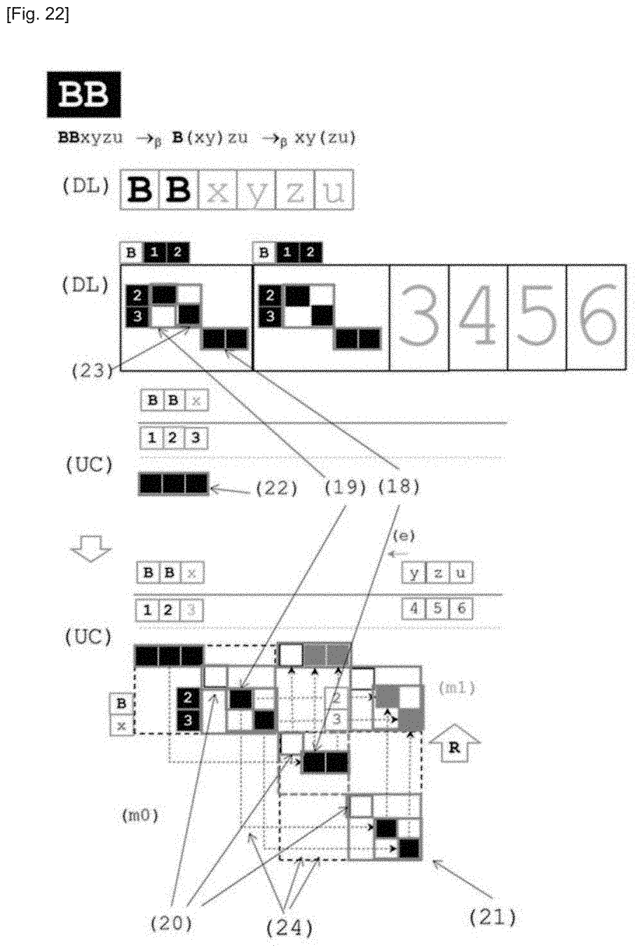

The set of different word structures (17), constituted of the DOAG «product» with its extended «matrix» leaves as previously described, forms the software device or combinatory «program» (see [FIG. 22], the initialization of the computation since the software device); for understanding needs, the DOAG structure will be removed in the elementary or simple cases.

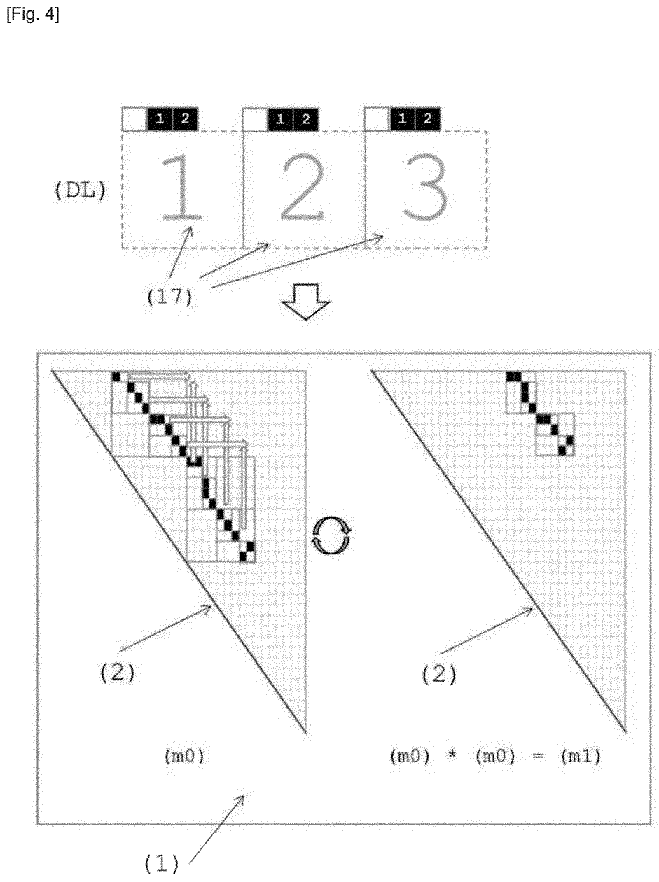

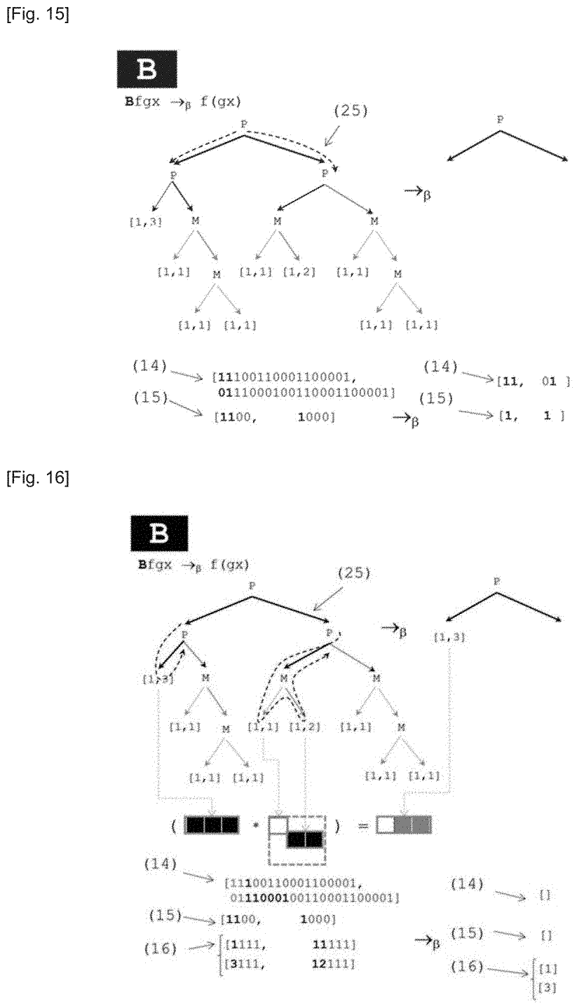

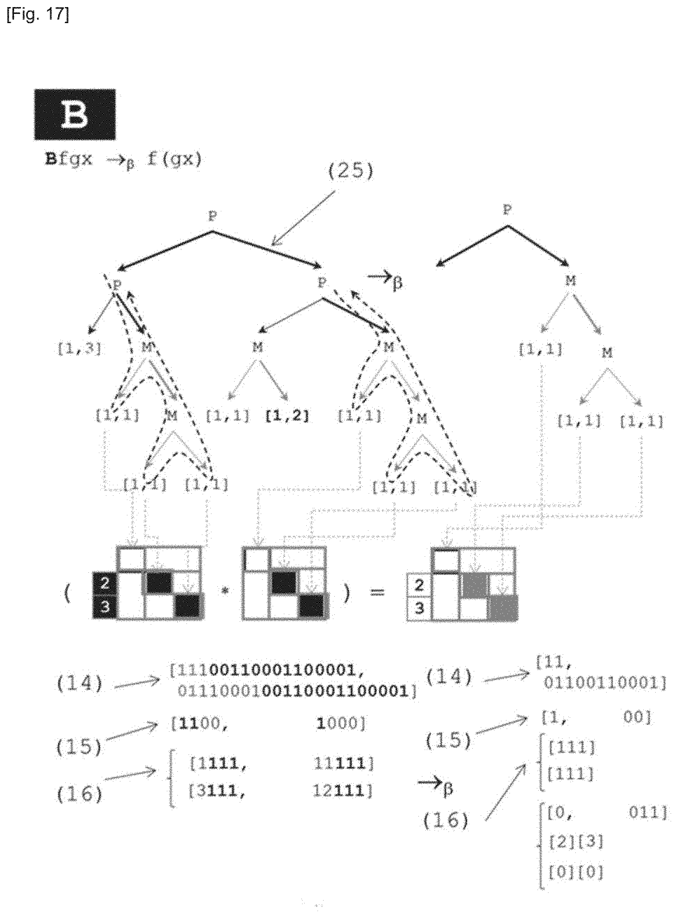

The matrix product made by the central processing unit, performing itself «above» the DOAG structure (or of words), the latter is a «miror» structure, so that the leaf matrices of left sub-DOAGs compose themselves with their analogues right sub-DOAGs compared to the root (see [FIG. 4], [FIG. 15], [FIG. 16] and [FIG. 17]).

The only constraints are therefore those related to the product lines per columns of the leaf matrices between them.

Each «local» binary product is directed by the number of lines of the left leaf matrix and the number of columns of the right leaf matrix, the «undefined» values are equal to ‘□’ or «zero» as described above.

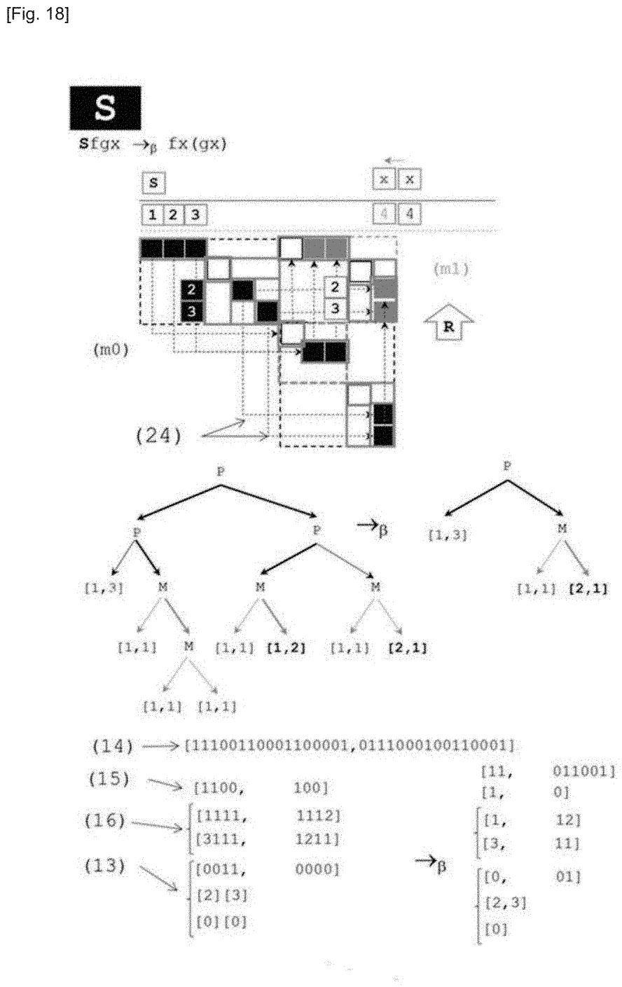

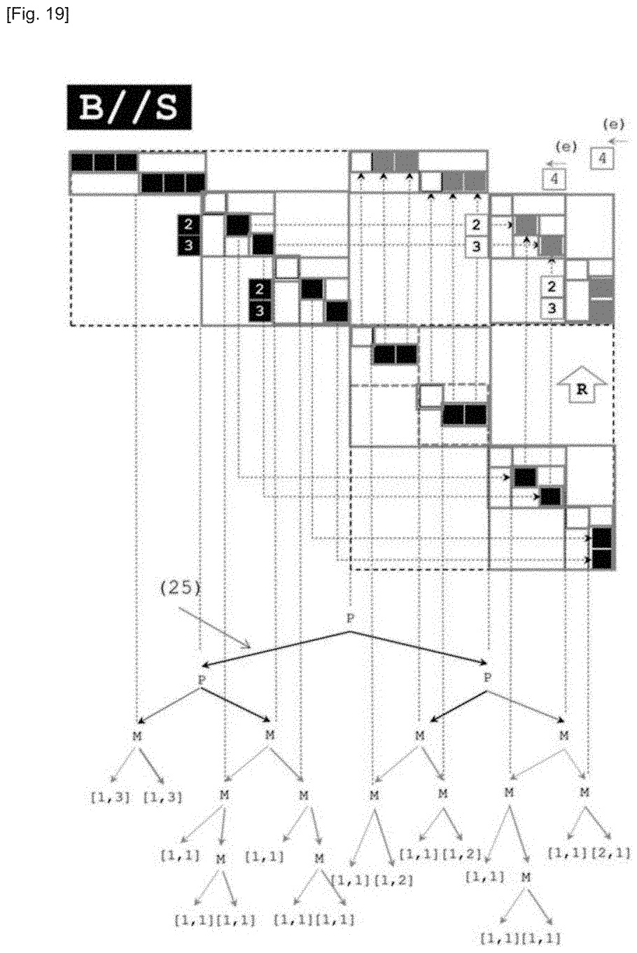

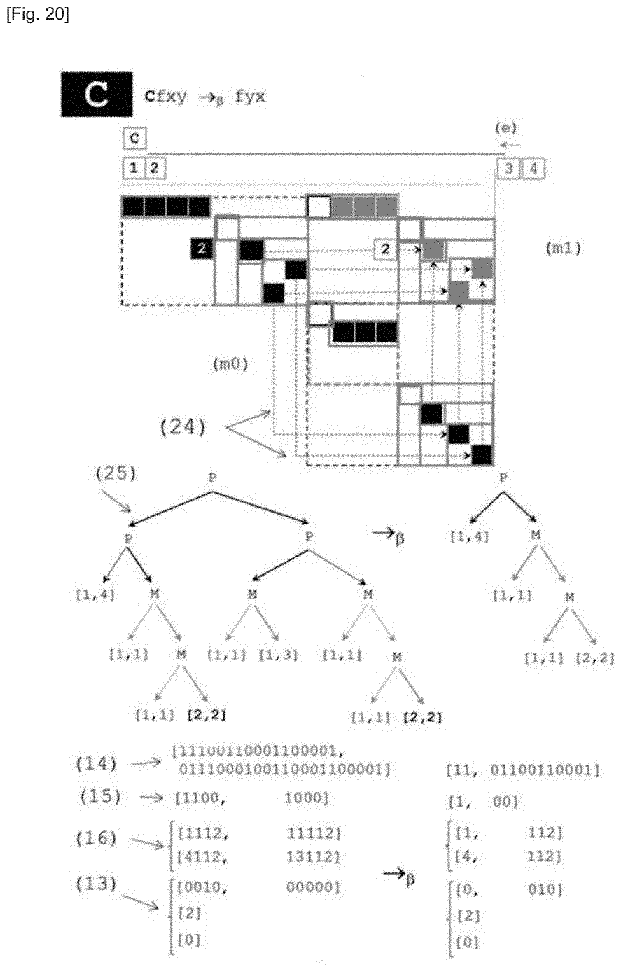

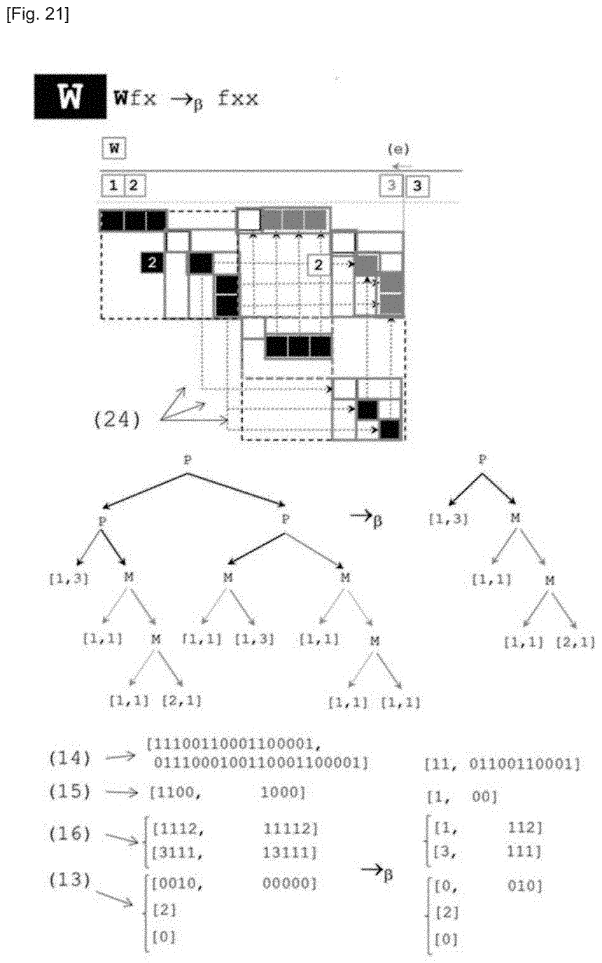

When there is no correspondence at the level of the terminal matrix (see for example the combinator S [FIG. 18]), a grouping of binary values at a higher level is performed.

The algorithm of DOAG traversal (and of DOAG computation) is as such performed by level or «class of equivalence» [FIG. 16] and [FIG. 17]:

The two branches or columns of the vector are simultaneously traversed (14), at each traversal of a «product» node (p) (other than the root) the traversal of following branches may be performed in parallel ([FIG. 17] and [FIG. 18]); there is no «return up» on the product nodes.

The word (15) allows to identify the depth of the computation, the reading of this word advances only when a ‘1’ is encountered on the word (14); at each cycle the depth is reduced by 1.

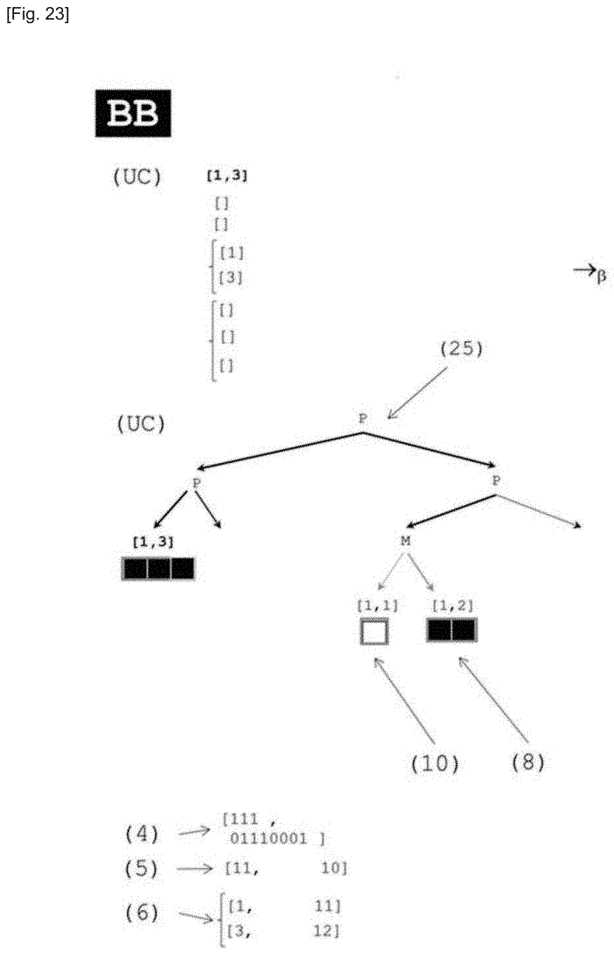

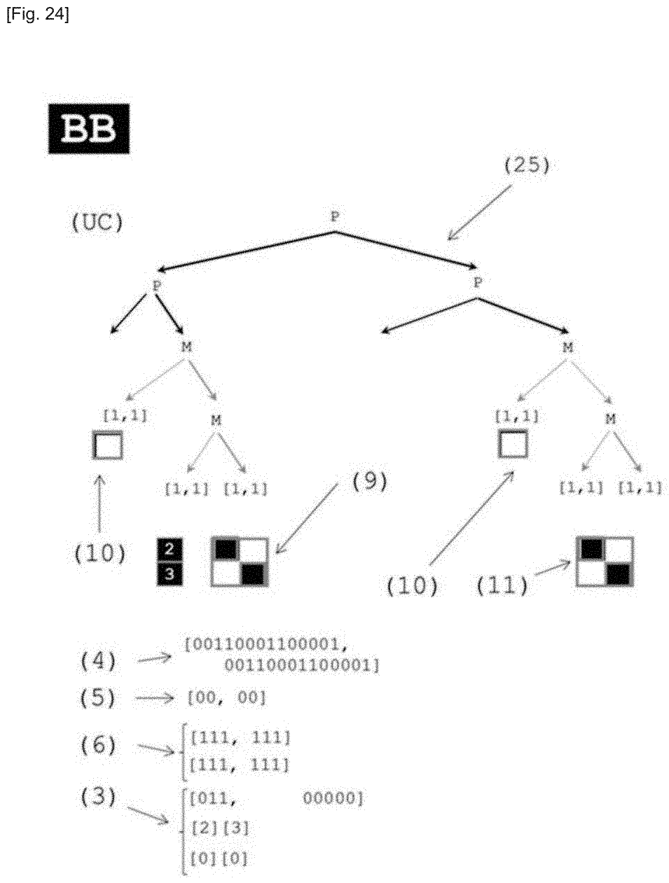

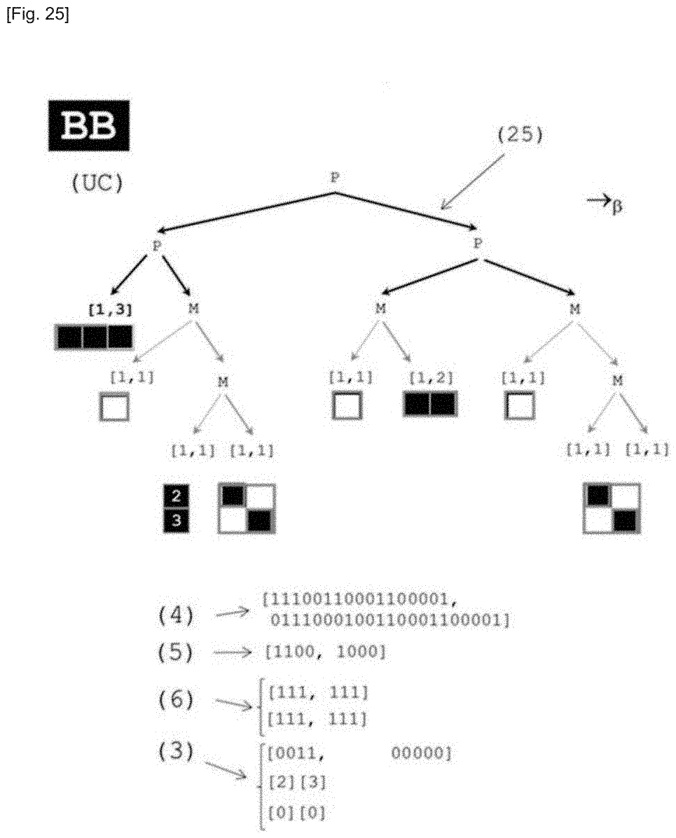

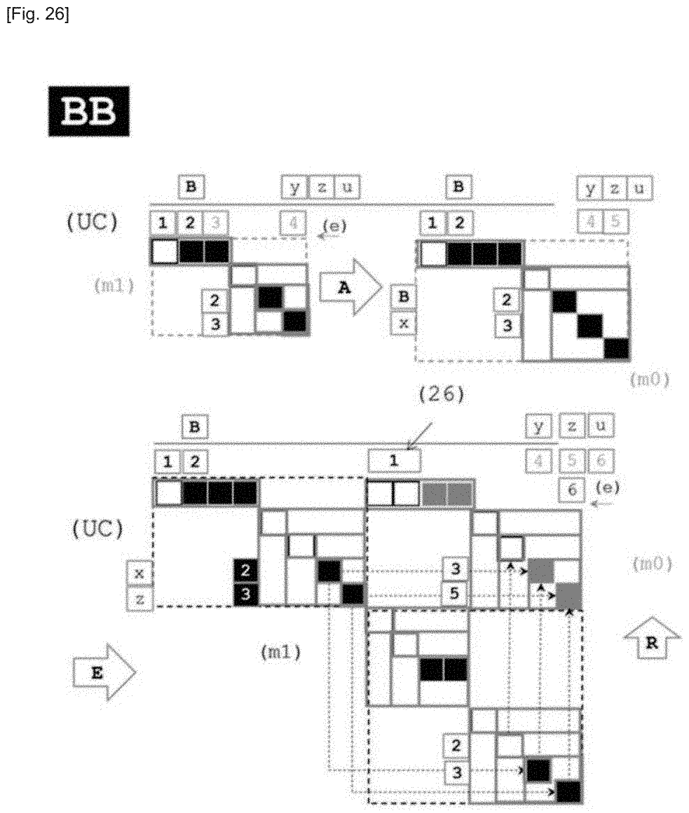

Each branch of the said DOAG can be traversed in parallel (see [FIG. 17] for the reduction; [FIG. 23] and [FIG. 24] for the construction or expansion).

If the DOAG traversal encounters another product node, then each sub-branch is traversed in parallel also: the «left son» then resumes the DOAG at the current level and the «right son» resumes the DOAG word at the next ‘0’.

A terminal matrix must compose with another one or a «leaf» matrix; the number and the organization of the resulting leaf matrices are determined by the leaf matrices product.

The size of the last «left» terminal matrix defines the number of operands (index) that simultaneously enter in the matrix product (e).

During the reduction phase of the matrix product, gradually as the descent of the DOAG product occurs, the central processing unit assigns (in parallel) respectively the places for the writing of the results.

The size and therefore the places of these words in the resulting word are simply deduced from the corresponding line and column words, by the lines of the left matrix and the columns of the right matrix.

The different words of the resulting matrix product are deduced from the traversed DOAG and constructed according to the same principles as the traversal occurs, independently from the values of the said dimensions.

In an analogous way, during the construction or expansion phase, the words (or matrices) can be constructed according to the same principles as the «in miror» diagonally matrix.

The word representing the indexes is therefore copied again in the resulting and corresponding matrix(ces) according to the properties of the matrix product.

The algorithm of matrix product is performed on the matrix nodes or the leaves; once it is achieved, the processing resources of the central unit are released to serve again to other computations in the part (2) opposite to the current part and so on.

The present method of computation is thus characterized by two antagonistic actions:

The first action, through the matrix product, aims to construct or concentrate the software devices in more and more reduced matrices, until it obtains connections or applications between places (index) or by default a product (to remind there is no operation allowing to «group» indexes or applying them one over another in a same word—certain figures derogate this principle, [FIG. 27], to allow the understanding and the distinction with other approaches which develop them from pointers on memory addresses).

The second is «inverse» to the first and aims to construct some products or diagonally matrices such as the connections between the indexes are performed by the reading above the product.

If an application between this index appears inside the matrix product, the diagonally matrix structure is modified to introduce a «delay» in the application of the indexes, at the same reading value of the corresponding applicative expression by reading above the matrix product.

The corresponding algorithm is relatively simple: it is necessary to construct some inverse products of «identity» diagonally matrix whose values are immediately deduced from the current product by «reading equality».

The matrices being linked two by two in a product, if a matrix is processed, then the homologous matrix also, so that the reading above is preserved for the product.

These two antagonistic actions are performed by the three phases called Application (A), Extension (E) and Reduction (R).

The present invention thus aims to construct matrix expressions that «are sufficient on their own», that is to say, they integrate all the transformations (as for example the successive erasures of the applications) relating to the application of combinators to each other, encoded by the binary matrix product itself.

The said central processing unit (1) includes two identical parts (2) and opposite in their operation, each one including a triangular matrix (2) of binary diagonally matrices (4) extended with an index word (13) for each dimension, each part (2) being also extended with one additional index word (e); each part (2) serving by turns respectively as a computation support (5) by the extension into a square matrix of the said triangular matrix of the said current part (2), and for the corresponding effective result, through an extended matrix product operation (5) of the said square matrix by itself; or in an equivalent manner for each part (2) respectively, including a set of binary memory words (14), (15) extended with additional index words (13), (16), (e), each index referring to places in the said sequence of binary words (17) of elements of the same nature (4) defining the said software device.

The right upper matrix is arbitrarily retained as the starting matrix in the present description. Each part or triangular matrix successively serves to write the result of the composition of the opposite part extended to a square matrix.

The synchronization of the technical parallelism is thus automatically performed at each cycle, independently of the current software device.

In the following phases, the different changes of the matrices can be performed by fully relying on the DOAG structure, that is to say by adding some branch to the latter, as well as leaf matrices, by successive writings into each respective part of the central processing unit.

For each transformation, the central processing unit reserves, in a first step, a memory space of which it can easily know the size from the leaves of the DOAG product of the «source» diagonally matrix or from theses of the software device: sum of the lines of the «left» leaf matrices and sum of the columns of the «right» leaf matrices.

A certain number of tests can be performed at each moment to check the consistency of the software device (see the global illustration [FIG. 4] and the particular case [FIG. 22]):

The first matrix (left) must begin at the column equal to its own number of lines+1.

The left lower «corner» of the matrix (left) «touches» or descends to the diagonal.

The second matrix (right) must have the same number of lines as the number of columns of the left matrix.

The right matrix begins at the right lower «corner» of the left matrix and must also descends to the diagonal.

Each matrix may be subdivided into a different number of sub-matrices, but such that the «sum» of the matrices respects the properties of the matrix product.

The matrix product structure is global and «above» the different matrices, which considered separately may not be able to compose with their homologous matrix.

APPLICATION PHASE: The extended matrix product operation (5) includes a first phase (A) of duplication of a value of the index word (e) in a new column of the said index word (e), also moving the corresponding value «true» or «1» in a new column of the corresponding binary matrix (4), with the same current values (6) according to the reading above the matrix product.

The said phase (A) is successively performed in each of the said opposite triangular parts (2), by successive writings of binary diagonally matrices (4) as long as there are several values «true» or «1» on the same column of a given binary matrix (4), that is, on the same index value (13), during the successive readings of the current values (6) by the said central processing unit (1).

EXPANSION PHASE: The extended matrix product operation (5) includes a second phase (E) adding a column with the value «true» or «1» on the right, to a left binary matrix (11) according to a matrix product (4) given by the said matrix product operation (5), and adding a line (to the bottom) and a column (to the right) such that the value «to the bottom on the right», or on the diagonal, is «true» or «1», of the corresponding right matrix (12) of the said product.

The said phase (E) is successively performed in (5) each of the said opposite triangular parts (2), by successive writings (5) of binary diagonally matrices (4), as long as the number of lines added by one unit, of the left matrix of the software device (17), given by the first index (13) of the given current value according to the reading above the product, is different from the number of columns of the left matrix (4) of the said matrix product operation of the current part (2).

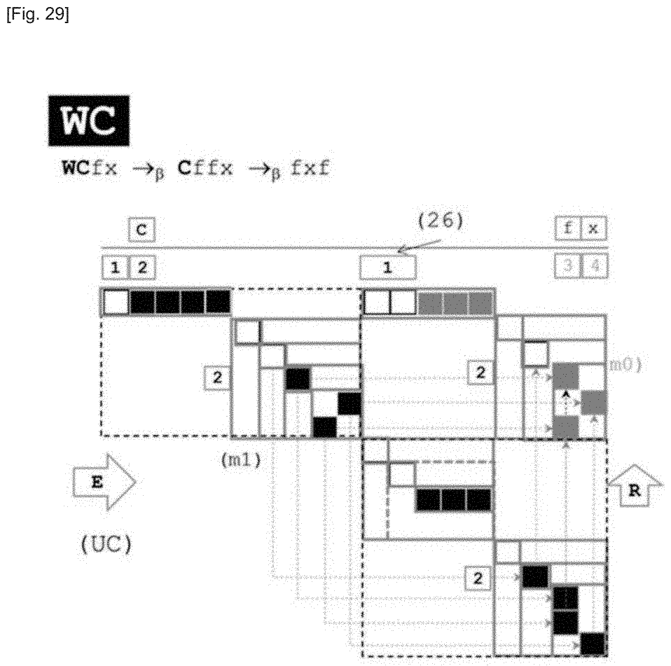

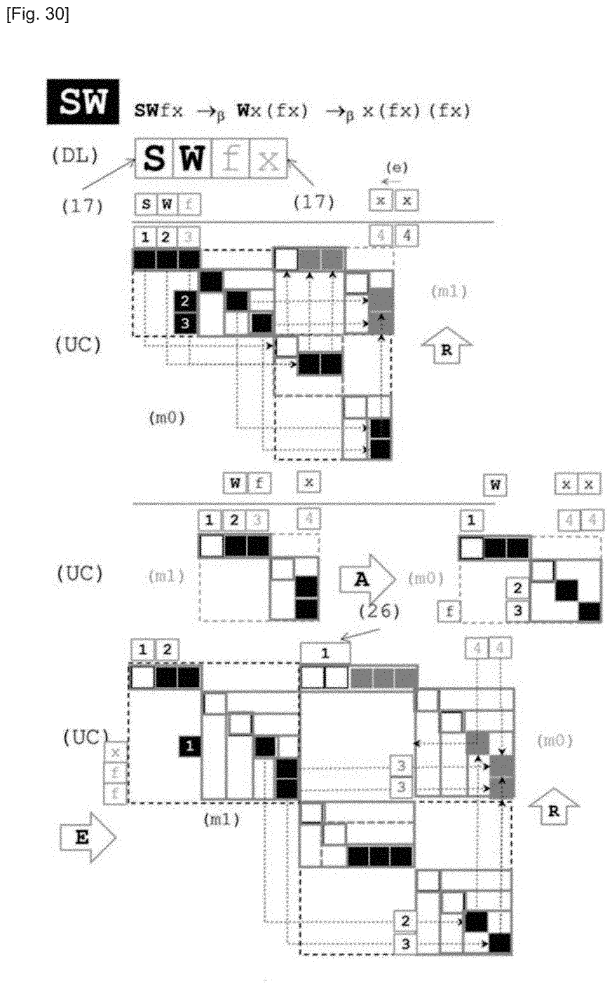

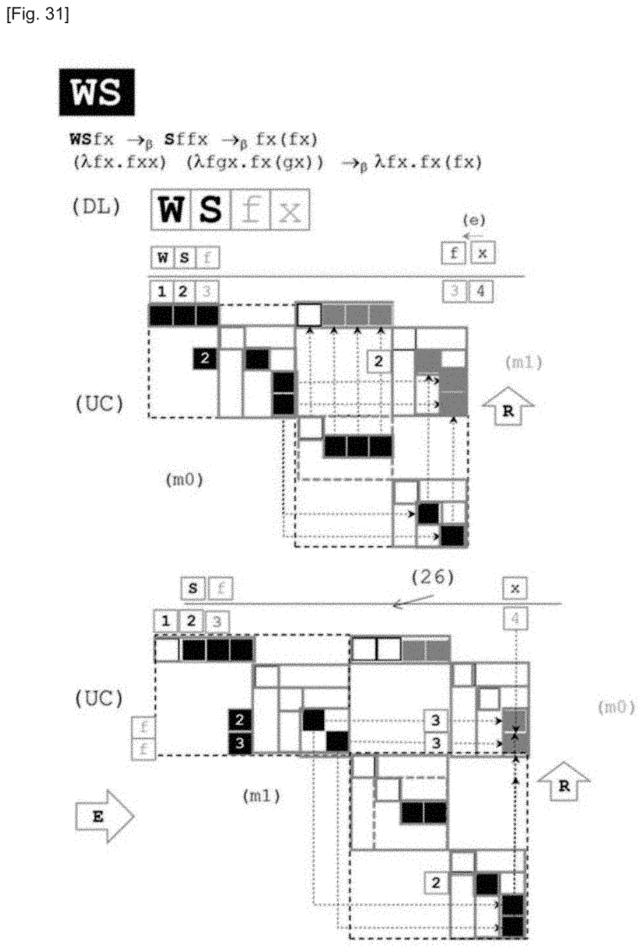

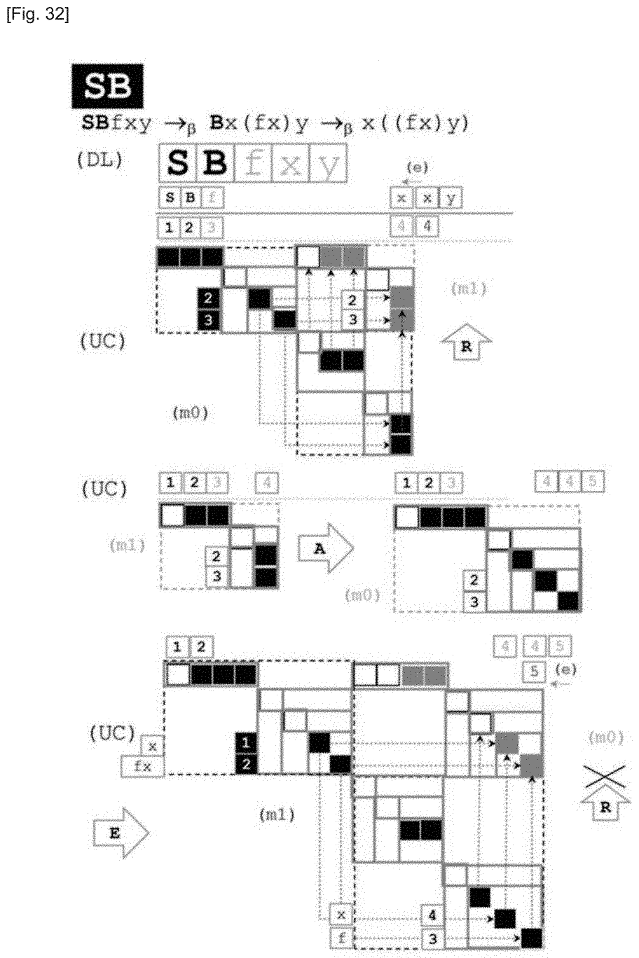

REDUCTION PHASE: The extended matrix product operation (5) includes a third phase (R) in the immediate absence of applications between indexes during the product, that follows, of the said left matrix with the corresponding right matrix [FIG. 32]; that is in the absence of a common occupied position during the comparison of the «column» index words, of the left and right matrix; in a first step, the transformation of the sequence of the binary diagonally matrix of the current part (2), in the said opposite part (2), into another sequence of binary diagonally matrices (25) added of two matrices, (19) and (18), by the middle (14) of the current product (24); and in a second step, the effective matrix product operation in the opposite part (2).

During the first step, the left matrix of the software device (17) identified by the head index (13) of the given current result according to the claim 2, is copied with its indexes (13) added of one unit, inside, at the middle on the left (19) and shifted of one erasure (20) to the right and to the bottom, or «to the bottom on the right», in the said opposite binary diagonally matrix; and the right matrix (18) of the corresponding product is constituted by a line word of «true» or «1», also shifted of one line and one column to the right and to the bottom.

In the presence of a «direct» or «internal» application of index, the said copy is performed by delaying the application by making copies of the corresponding left and right matrices into new diagonally matrices that are extended to the identity, such that the result of the product of these diagonally matrices is at the same reading value as the current product; a «lazy» or «delay» principle available for all applications distinct from the head application.

The construction of the said new diagonally matrices is relatively simple. The size of the said «identity» matrix is given by the «left» leaf matrix of the current product, then the current reading above the product gives the respective values of the lines and columns as well as the corresponding indexes, such that there is identity of the reading above the product.

During the second step of the reduction phase (R), that is during the effective matrix product to the opposite part (2), the index word (e) shifts towards the inside of the matrix product according to the number of columns of the last left matrix of the current global product.

1. Functional Method for Universal Computation by Extended Formal Matrix Product to perform applicative computations by means of a central processing unit (1) and the corresponding software device (17) characterized in that the said central processing unit (1) includes two identical parts (2) and opposite in their operation, each one including a triangular matrix (2) of binary diagonally matrices (4) extended with an index word (13) for each dimension, each part (2) being also extended with one additional index word (e); each part (2) serving by turns respectively as a computation support (5) by the extension into a square matrix of the said triangular matrix of the said current part (2), and for the corresponding effective result, through an extended matrix product operation (5) of the said square matrix by itself; or in an equivalent manner for each part (2) respectively, including a set of binary memory words (14), (15) extended with additional index words (13), (16), (e), each index referring to places in the said sequence of binary words (17) of elements of the same nature (4) defining the said software device.

2. Method according to the claim 1 characterized in that the order of the current values of the applicative expressions (6) is given by the order formed by the product (24) of the said binary matrices (4) and each value (6) is effectively given by the values of the said indexes (13) associated to each dimension, corresponding to the values «true» or «1» of the said binary matrices (4) of the current part (2), read according to the said traversal order (24).

3. Method according to the claim 1 and the claim 2 characterized in that the extended matrix product operation (5) includes a first phase (A) of duplication of a value of the index word (e) in a new column of the said index word (e), also moving the corresponding value «true» or «1» in a new column of the corresponding binary matrix (4), with the same current values (6) according to the claim 2.

4. Method according to the claim 2 and the claim 3, characterized in that the said phase (A) is successively performed in each of the said opposite triangular parts (2), by successive writings of binary diagonally matrices (4) as long as there are several values «true» or «1» on the same column of a given binary matrix (4), that is, on the same index value (13), during the successive readings of the current values (6) by the said central processing unit (1) according to the claim 2.

5. Method according to the claim 1, characterized in that the extended matrix product operation (5) includes a second phase (E) adding a column with the value «true» or «1» on the right, to a left binary matrix (11) according to a matrix product (4) given by the said matrix product operation (5), and adding a line (to the bottom) and a column (to the right) such that the value «to the bottom on the right», or on the diagonal, is «true» or «1», of the corresponding right matrix (12) of the said product.

6. Method according to the claim 5 and the claim 2, characterized in that the said phase (E) is successively performed in (5) each of the said opposite triangular parts (2), by successive writings (5) of binary diagonally matrices (4), as long as the number of lines added by one unit, of the left matrix of the software device (17), given by the first index (13) of the given current value according to the claim 2, is different from the number of columns of the left matrix (4) of the said matrix product operation of the current part (2).

7. Method according to the claim 1 and the claim 2 characterized in that the extended matrix product operation (5) includes a third phase (R) in the immediate absence of applications between indexes during the product, that follows, of the said left matrix with the corresponding right matrix [FIG. 32]; that is in the absence of a common occupied position during the comparison of the «column» index words, of the left and right matrix; in a first step, the transformation of the sequence of the binary diagonally matrix of the current part (2), in the said opposite part (2), into another sequence of binary diagonally matrices (25) added of two matrices, (19) and (18), by the middle (14) of the current product (24); and in a second step, the effective matrix product operation in the opposite part (2).

8. Method according to the claim 7 and the claim 2 characterized in that in a first step, the left matrix of the software device (17) identified by the head index (13) of the given current result according to the claim 2, is copied with its indexes (13) added of one unit, inside, at the middle on the left (19) and shifted of one erasure (20) to the right and to the bottom, or «to the bottom on the right», in the said opposite binary diagonally matrix; and the right matrix (18) of the corresponding product is constituted by a line word of «true» or «1», also shifted of one line and one column to the right and to the bottom.

9. Method according to the claim 7 and the claim 2 characterized in that in the presence of a «direct» or «internal» application of index, the said copy is performed by delaying the application by making copies of the corresponding left and right matrices into new diagonally matrices that are extended to the identity, such that the result of the product of these diagonally matrices is at the same reading value as the current product according to the claim 2.

10. Method according to the claim characterized in that during the second step of the reduction phase (R), that is during the effective matrix product to the opposite part (2), the index word (e) shifts towards the inside of the matrix product according to the number of columns of the last left matrix of the current global product.
